(19) United States
(12) Patent Application Publication
(10) Pub. No.: US 2008/0224610 A1
(43) Pub. Date: Sep. 18, 2008

(54) PLASMA DISPLAY PANEL WITH REDUCED POWER CONSUMPTION

(76) Inventors: Hyun Soh, Yongin-si (KR); Yun-Hee Kim, Yongin-si (KR); Hyun Kim, Yongin-si (KR); Jin-Won Han, Yongin-si (KR)

Correspondence Address: CHRISTIE, PARKER & HALE, LLP, PO BOX 7068, PASADENA, CA, 91109-7068, US

(21) Appl. No.: 12/048,122

(22) Filed: Mar. 13, 2008

(30) Foreign Application Priority Data
Mar. 14, 2007 (KR) 10-2007-0025020

(51) Int. Cl. H01J 17/49

(52) U.S. Cl. 313/586

(57) ABSTRACT

A plasma display panel is provided having a front and rear substrates. Barrier ribs extend between the front and rear substrates to form discharge cells. First and second electrodes are on the front substrate and extend in a first direction and face each other in respective discharge cells to form a discharge gap. A dielectric layer covers the first and second electrodes. A phosphor layer is formed in each of the discharge cells. The barrier ribs have first barrier rib portions that extend in the first direction and second barrier rib portions that extend in a second direction crossing the first direction. The first electrodes extend over the first barrier rib portions and pairs of the second electrodes extend along each side of the first electrodes and protrude into the respective discharge cells to the discharge gap.

### CROSS-REFERENCE TO RELATED APPLICATION

This application claims priority to and the benefit of Korean Patent Application No. 10-2007-0025020, filed in the Korean Intellectual Property Office on Mar. 14, 2007, the entire content of which is incorporated herein by reference.

### BACKGROUND OF THE INVENTION

1. Field of the Invention

The present invention relates to a plasma display panel with reduced power consumption.

2. Description of Related Art

Generally, a plasma display panel (“PDP”) is a display device that excites phosphors with ultraviolet rays radiated from the plasma by discharging gas. The excited phosphors generate visible light for displaying desired images.

The PDP is commonly made with a triode surface discharge structure where a pair of electrodes are formed on a surface of a front substrate and a rear substrate is spaced apart from the front substrate with address electrodes. The electrodes are located corresponding to respective discharge cells.

Several millions of unit discharge cells are arranged within the PDP in the form of a matrix. The discharge cells are selected for turning on using the memory characteristic of wall charges and the selected discharge cells are discharged to display the desired images. Within the selected discharge cells, the sustain discharge excites the phosphors, and accordingly, visible rays with inherent frequency bands are generated, thereby displaying the desired images.

A dielectric layer covers the electrodes to protect them. A parasitic capacitance formed between the electrodes heightens the power consumption. The parasitic capacitance is physically proportional to the electrode area.

### SUMMARY OF THE INVENTION

A PDP is provided having a front substrate and a rear substrate facing the front substrate. Barrier ribs extend between the front substrate and the rear substrate to form discharge cells. First electrodes and second electrodes are on the front substrate and extend in a first direction and face each other at respective discharge cells to form a discharge gap. A dielectric layer covers the first electrodes and the second electrodes. A phosphor layer is formed in each of the discharge cells. The barrier ribs have first barrier rib portions and second barrier rib portions. The first barrier rib portions extend in the first direction. The second barrier rib portions extend in a second direction crossing the first direction. The first electrodes extend over the first barrier rib portions and pairs of the second electrodes extend along each side of the first electrodes and protrude into the respective discharge cells to the discharge gap.

According to an exemplary embodiment of the present invention, the second electrodes extend over centers of the discharge cells.

According to an exemplary embodiment of the present invention, the discharge gap is biased towards the first electrodes such that the discharge gap is closer to the first barrier rib portions nearest the first electrodes than the first barrier rib portions nearest the second electrodes.

According to an exemplary embodiment of the present invention, the second electrodes include a bus electrode extending in the first direction over the discharge cells and include transparent electrodes protruding from the bus electrode toward the first electrodes.

According to an exemplary embodiment of the present invention, the first electrodes include a bus electrode extending in the first direction over the first barrier rib portions and include transparent electrodes traversing the bus electrode and extending over a pair of discharge cells adjacent to each other in the second direction.

A PDP is provided having a front substrate and a rear substrate facing the front substrate. Barrier ribs extend between the front substrate and the rear substrate to form discharge cells. First electrodes and second electrodes are on the front substrate and extend in a first direction and face each other at respective discharge cells with a discharge gap. A dielectric layer covers the first electrodes and the second electrodes. A phosphor layer is formed in each of the discharge cells. The barrier ribs have first barrier rib portions and second barrier rib portions. The first barrier rib portions extend in the first direction. The second barrier rib portions extend in a second direction crossing the first direction. The first barrier rib portions closest to the first electrodes are spaced apart from each other to form channels. The first electrodes extend over the channels and pairs of the second electrodes extend along each side of the first electrodes and protrude into the respective discharge cells to the discharge gap.

According to an exemplary embodiment of the present invention, the channels are alternately disposed between a pair of discharge cells neighboring each other in the second direction.

A PDP is provided having a front substrate and a rear substrate facing the front substrate. Barrier ribs extend between the front substrate and the rear substrate to form discharge cells. First electrodes and second electrodes are on the front substrate and extend in a first direction and face each other at respective discharge cells with a discharge gap. A dielectric layer covers the first electrodes and the second electrodes. A phosphor layer is formed in each of the discharge cells. The barrier ribs have channels extending in the first direction, and the channels are alternately disposed between a pair of discharge cells neighboring each other in the second direction crossing the first direction.

According to an exemplary embodiment of the present invention, the discharge cells each have discharge cell width sides and discharge cell length sides longer than the discharge cell width sides. The discharge gap is biased towards the first electrodes such that the discharge gap is nearer to the discharge cell width sides nearest to the first electrodes than to the discharge cell width sides nearest to the second electrodes.

### BRIEF DESCRIPTION OF THE DRAWINGS

FIG. 1 is an exploded perspective view of a PDP according to an embodiment of the present invention.

FIG. 2 is a plan view of the PDP shown in FIG. 1, illustrating the positional relationship between the discharge cells and the display electrodes.

FIG. 3 is an electrode diagram of the PDP, illustrating the arrangement of the display electrodes.

FIG. 4 is a cross-sectional view of the PDP taken along the IV-IV line of FIG. 2.

FIG. 5 is a plan view of a PDP according to a second embodiment of the present invention, illustrating the positional relationship between display electrodes and discharge cells.

### DETAILED DESCRIPTION

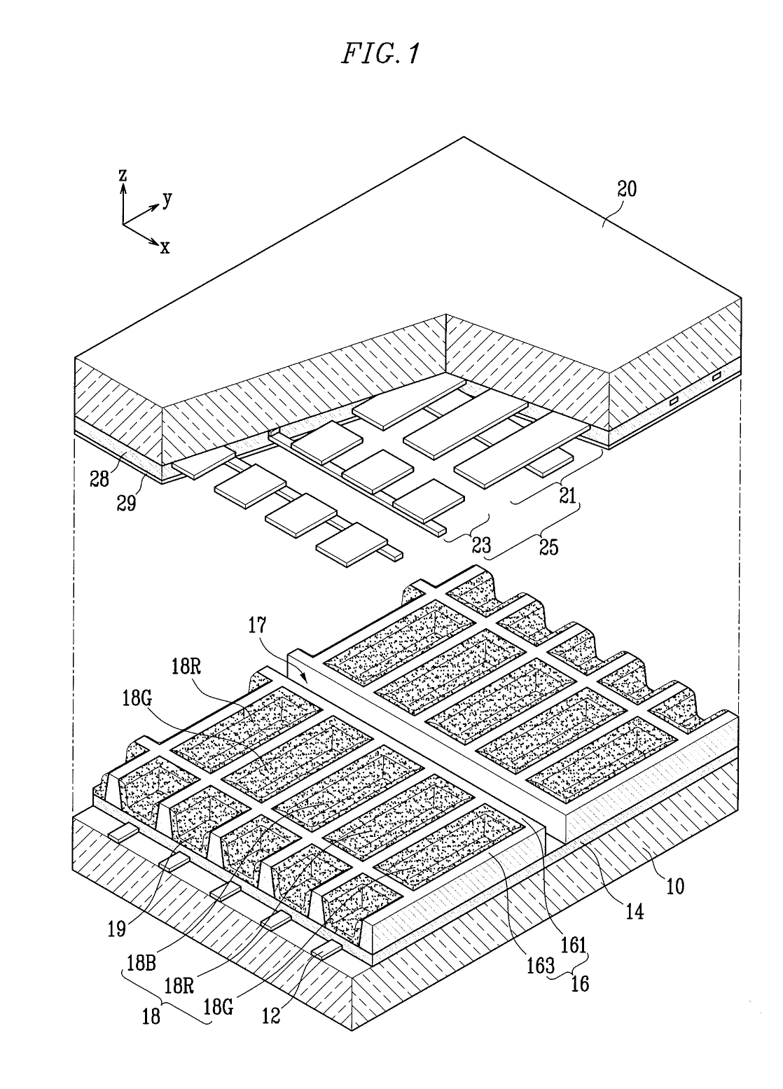

Referring to FIG. 1, the front substrate 20 and rear substrate 10 face each other, and the space therebetween is demarcated by barrier ribs 16 that form discharge cells 18. The barrier ribs 16 are partially bordered by channels 17, which form exhaust ducts between the discharge cells.

Display electrodes 25 and address electrodes 12 cross each other along the discharge cells 18, and a dielectric layer 28 covers the display electrodes 25 with a dielectric material.

Specifically, the front substrate 20 is formed with a transparent material based on reinforced glass to transmit light. The desired images are displayed on the front substrate 20 due to the discharging of the discharge cells 18.

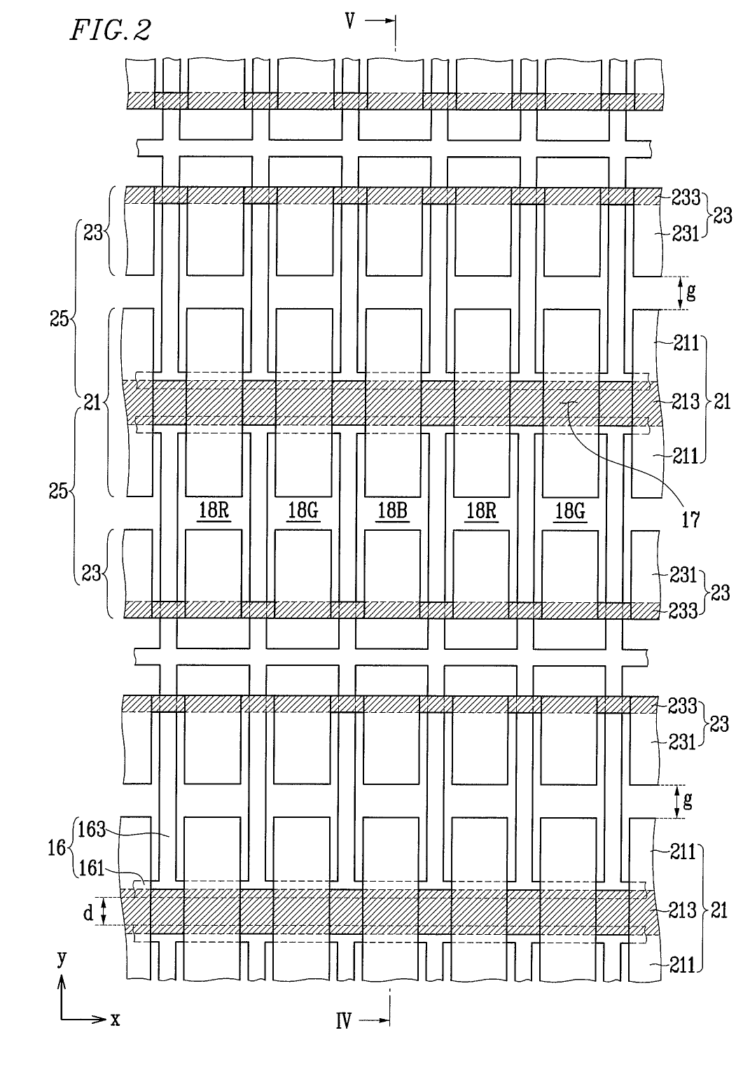

The display electrodes 25 are formed corresponding to the respective discharge cells 18. Each display electrode 25 is formed as a pair of a second electrode (referred to hereinafter as a scan electrode) 23 and a first electrode (referred to hereinafter as a sustain electrode) 21. As shown in FIG. 2, the scan electrodes 23 and sustain electrodes 21 face each other at the discharge cells 18 with a discharge gap g. The scan electrodes 23 are operated in association with the address electrodes 12 to select the turn-on discharge cells 18, and the sustain electrodes 21 are operated in association with the scan electrodes 23 to discharge the selected discharge cells 18 during the sustain period.

The display electrodes 25 are covered by the dielectric layer 28 formed of a dielectric material such as PbO, B₂O₃, and SiO₂. The dielectric layer 28 prevents the display electrodes 25 from being damaged due to collisions of charged particles during the discharging.

A passivation film 29 is formed on the dielectric layer 28. The passivation film 29 prevents the dielectric layer 28 from being damaged due to the direct collisions of charged particles thereupon. When collided with the charged particles, the passivation film 29 emits secondary electrons that heighten the discharge efficiency.

The address electrodes 12 are formed on a surface of the rear substrate 10 facing the front substrate 20. As shown in the drawing, the address electrodes 12 cross the display electrodes 25, and extend in a direction (in the y axis direction of the drawing) corresponding to the respective discharge cells 18 parallel to each other. Accordingly, with the overall structure of the rear substrate 10, the address electrodes 12 are wholly stripe-patterned. The address electrodes 12 are operated in association with the scan electrodes 23 to select the turn-on discharge cells 18.

The address electrodes 12 are covered by a dielectric layer 14. The barrier ribs 16 are formed on the dielectric layer 14 each with a first barrier rib portion 161 for dividing the discharge cells 18 in a first direction (in the x axis direction of the drawing), and a second barrier rib portion 163 proceeding in a second direction (in the y axis direction of the drawing) crossing the first barrier rib portion 161. The first barrier rib portions 161 space the discharge cells neighboring in the second direction from each other to form a channel 17 between the discharge cells.

Phosphor layers 19 are formed within the discharge cells 18 to emit visible rays per the respective colors. Depending upon the colors emitted from the phosphor layers 19, the discharge cells 18 are classified into red, green, and blue discharge cells 18R, 18G, and 18B, respectively.

The discharge cells 18 with the phosphor layers 19 are internally filled with mixed discharge gas of neon, xenon, and the like.

FIG. 2 is a plan view of the PDP shown in FIG. 1, illustrating the positional relationship between the discharge cells 18 and the display electrodes 25. As shown in FIG. 2, the barrier ribs 16 each have a first barrier rib portion 161 formed in a first direction (in the x axis direction of the drawing), and a second barrier rib portion 163 formed in a second direction (in the y axis direction of the drawing) crossing the first direction.

The first barrier rib portions 161 extend in the first direction to demarcate the discharge cells 18 neighboring each other in the second direction (in the y axis direction of the drawing). Furthermore, the first barrier rib portions 161 form channels 17 between the pair of discharge cells 18 neighboring each other in the second direction. That is, every other first barrier rib portions 161 for dividing the discharge cells 18 in the first direction are formed in pairs. Each pair of first barrier rib portions 161 are spaced apart from each other with a distance d (e.g., a predetermined distance) so that a channel 17 is formed between the first barrier rib portions 161 in the first direction. With the closed discharge cell structure, the channel 17 forms an exhaust passage between the discharge cells 18. Consequently, even with the closed discharge cell structure, it becomes easy to inject the discharge gas into the discharge cells or remove the impurities.

In addition, according to this embodiment, a decrease in aperture ratio can be minimized by fully maintaining the area of the discharge cells while the exhaust efficiency improved through the channels, since the channels may be alternately disposed between a pair of the discharge cells neighboring each other in the second direction.

The scan and sustain electrodes 23, 21 of the display electrodes 25 face each other over the discharge cells 18 with a discharge gap g.

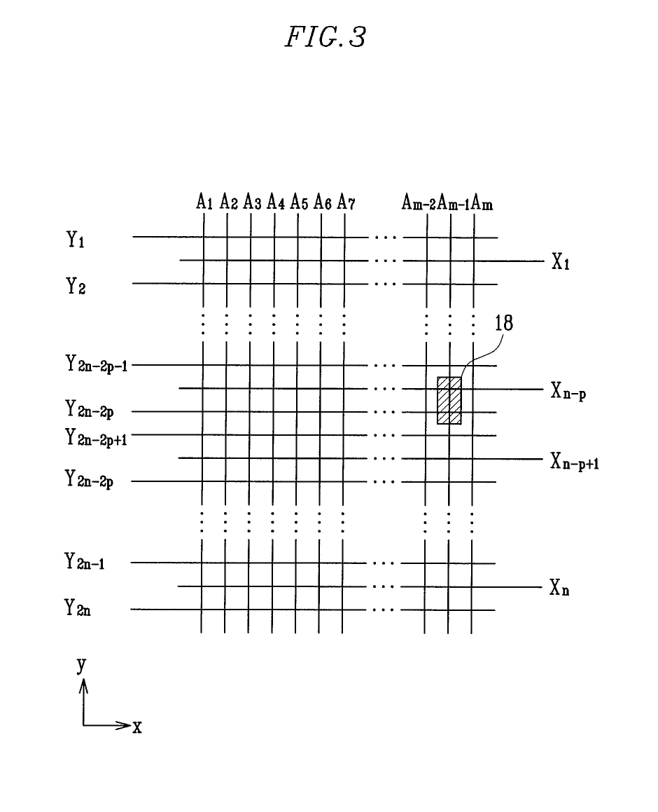

In an exemplary embodiment, the display electrodes 25 involve an arrangement structure exemplified in FIG. 3, in which the scan electrodes Yₖ are arranged parallel to and along a lengthwise side of each of the sustain electrodes Xₙ. As depicted in FIG. 3, scan electrodes Y₁, Y₂ correspond with sustain electrode X₁; scan electrodes Y₂ₙ₋₂ₚ₋₁, Y₂ₙ₋₂ₚ correspond with sustain electrode Xₙ₋ₚ; scan electrodes Y₂ₙ₋₂ₚ₊₁, Y₂ₙ₋₂ₚ₊₂ correspond to sustain electrode Xₙ₋ₚ₊₁; and scan electrodes Yₖ₋₁, Yₖ correspond with sustain electrode Xₙ. Scan electrodes that correspond with a sustain electrode are operated in association with the sustain electrode to discharge selected discharge cells during the sustain period.

Discharge cells 18 are formed along the crossed regions of the sustain electrodes Xₙ and scan electrodes Yₖ with the address electrodes Aₘ. The sustain electrodes Xₙ extend in the first direction (in the x axis direction), and the scan electrodes Yₖ extend in the first direction such that they are spaced apart from the sustain electrodes Xₙ with a gap g (e.g., a predetermined gap), and proceed parallel thereto. The address electrodes Aₘ extend in the second direction (in the y axis direction of the drawing) crossing the first direction to form discharge cells 18.

The sustain electrodes Xₙ are not formed at each respective discharge cell, but are shared by a pair of discharge cells neighboring each other in the second direction (in the y axis direction of the drawing). A pair of scan electrodes Yₖ are formed parallel to and along each lengthwise side of the sustain electrodes Xₙ.

Depending upon such an arrangement structure, the number of sustain electrodes 21 for forming the display electrodes 25 may be reduced by ½, compared to the conventional case. Consequently, the inter-electrode parasitic capacitance is reduced, thereby lowering the whole power consumption of the PDP.

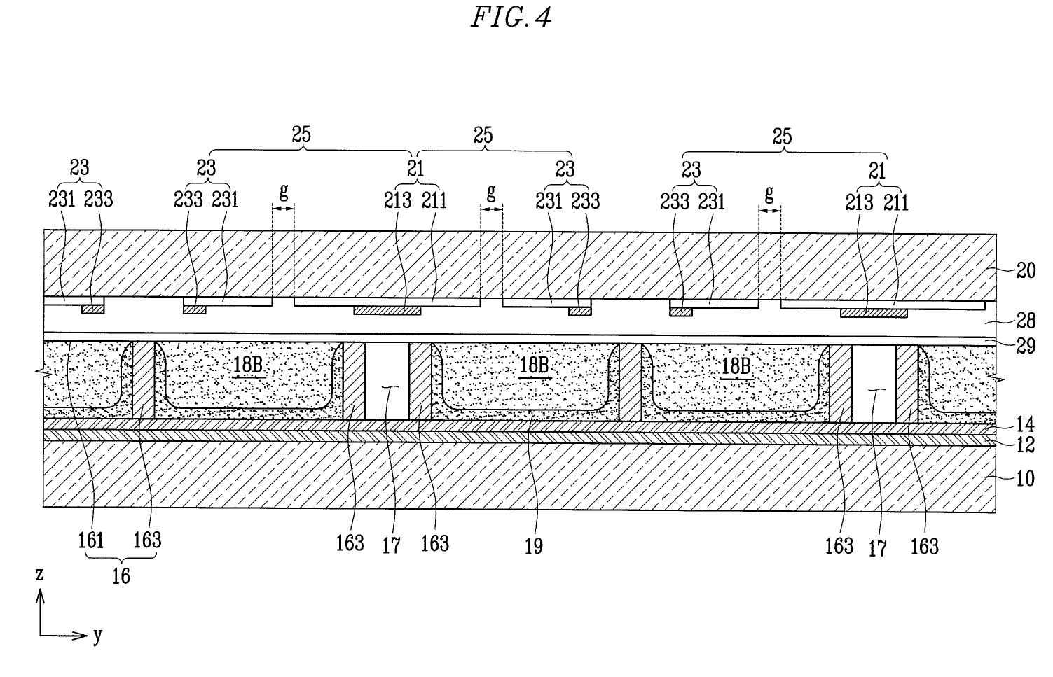

As shown in FIG. 2, the sustain electrodes 21 having the above arrangement structure may be formed each with a combination of a bus electrode 213 and transparent electrodes 211. The bus electrode 213 is placed directly over the channel 17 and extends in the first direction. Consequently, as shown in FIG. 4, the top surface of the channel 17 is shadowed by the bus electrodes 213 so that the bus electrodes 213 prevent the channel 17 from reflecting external light.

The transparent electrodes 211 traverse the bus electrodes 213, and extend over a pair of discharge cells 18 neighboring each other in the second direction.

A pair of scan electrodes 23 are formed parallel to and along a lengthwise side of each of the sustain electrodes 21. The scan electrodes 23 are formed with a combination of a bus electrode 233 and transparent electrodes 231 protruded from the bus electrode 233 toward the sustain electrodes 21.

Accordingly, the transparent electrodes 211 and 231 are placed over the discharge cells 18 with a discharge gap g.

With the arrangement structure of the sustain and scan electrodes 21, 23, the scan electrodes 23 are internally biased to the discharge cells 18, compared to the sustain electrodes 21. That is, the discharge gap g between the scan and sustain electrodes 23 and 21 is biased toward the sustain electrodes 21.

As the scan electrodes 23 are internally biased to the discharge cells 18, the scan electrodes 23 cross the address electrodes 12 at the centers of the discharge cells. Consequently, the address discharge between the scan and address electrodes 23 and 12 is made at the centers of the discharge cells, and hence, it becomes possible to enable the address driving more precisely.

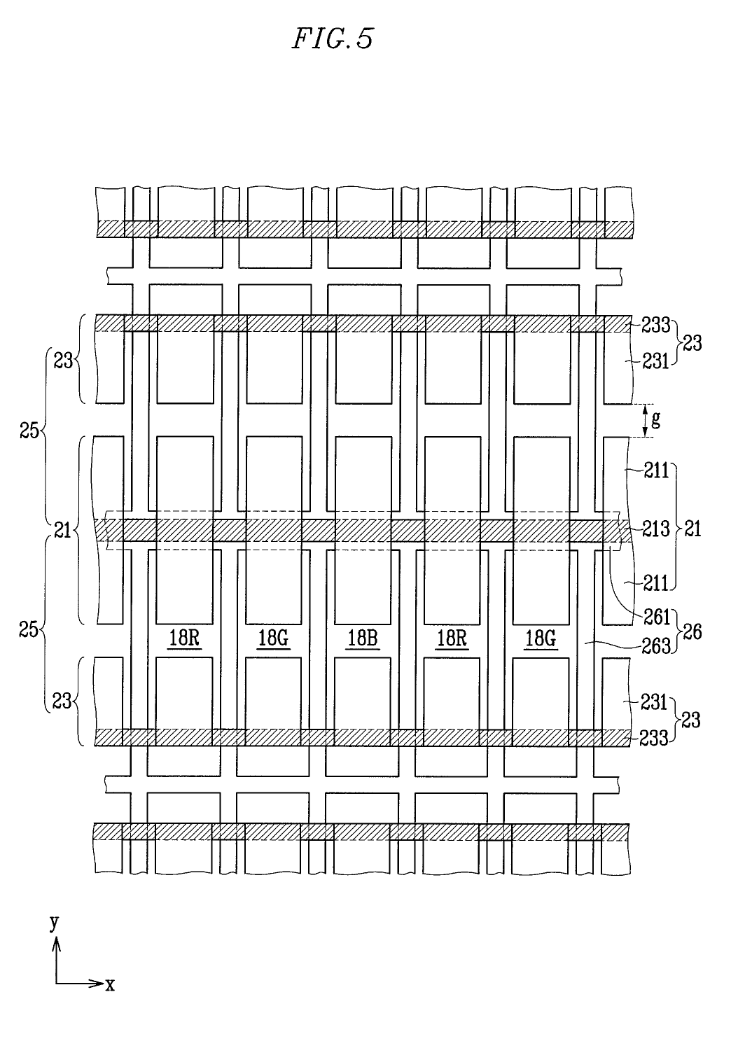

FIG. 5 is a plan view of a PDP according to a second embodiment of the present invention, illustrating the positional relationship between the discharge cells and the display electrodes. As shown in FIG. 5, like reference numerals are used with respect to the same structural components as those related to the previous embodiment, and a difference is made only in the structure of the barrier ribs for dividing the discharge cells.

As shown in FIG. 5, the barrier ribs 26 have first barrier rib portions 261 dividing the discharge cells 18 in a first direction (in the x axis direction of the drawing), and second barrier rib portions 263 dividing the discharge cells 18 in a second direction (in the y axis direction of the drawing).

The first barrier rib portions 261 extend in the first direction to demarcate the discharge cells 18 in the first direction. The second barrier rib portions 263 extend in the second direction such that they cross the first barrier rib portions 261, thereby dividing the discharge cells 18 in the second direction.

In an exemplary embodiment, the sustain electrodes 21 are formed with a combination of a bus electrode 213 and transparent electrodes 211. The bus electrodes 213 are placed directly over the first barrier rib portions 261 and extend in the first direction. The transparent electrodes 211 cross the bus electrode 213, and extend over a pair of discharge cells 18 neighboring each other in the second direction. The scan electrodes 23 are formed parallel to and along a lengthwise side of each of the sustain electrodes 21. The scan electrodes 23 are formed with a combination of a bus electrode 233 and transparent electrodes 231 protruded from the bus electrode 233 toward the sustain electrodes 21.

The bus electrodes 233 are internally biased to the discharge cells 18 and extend in a first direction. The transparent electrodes 231 protrude from the bus electrode 233 toward the sustain electrodes 21. The scan electrodes 23 are internally biased to the discharge cells, compared to the sustain electrodes 21. That is, the discharge gap g is biased towards the sustain electrodes such that the discharge gap is closer to the first barrier rib portions nearest the sustain electrodes than the first barrier rib portions nearest the scan electrodes.

As described above, the number of sustain electrodes forming the display electrodes is reduced by ½ compared to the conventional case, thereby decreasing the parasitic capacitance between the electrodes.

Furthermore, with the formation of the display electrodes, the sustain electrodes are formed directly over the channels so that the top surfaces of the channels are shadowed by the electrodes, thereby decreasing the reflection of external light from the channels.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a front substrate;
a rear substrate facing the front substrate;
barrier ribs between the front substrate and the rear substrate to form discharge cells;
first electrodes and second electrodes on the front substrate extending in a first direction and facing each other in respective discharge cells with a discharge gap;
a dielectric layer covering the first electrodes and the second electrodes; and
a phosphor layer in each of the discharge cells,
wherein the barrier ribs have first barrier rib portions extending in the first direction, and second barrier rib portions extending in a second direction crossing the first direction,
wherein the first barrier rib portions closest to the first electrodes are spaced apart from each other to form channels, the channels being alternately disposed between a pair of discharge cells neighboring each other in the second direction, and
wherein the first electrodes extend over the channels and pairs of the second electrodes extend along each side of the first electrodes and protrude into the respective discharge cells to the discharge gap.

2. The plasmas display panel of claim 1, wherein the discharge gap is biased towards the first electrodes such that the discharge gap is closer to the first barrier rib portions nearest the first electrodes than the first barrier rib portions nearest the second electrodes.

3. The plasma display panel of claim 1, wherein the second electrodes include a bus electrode extending in the first direction over the discharge cells and include transparent electrodes protruding from the bus electrode toward the first electrodes.

4. The plasma display panel of claim 1, wherein the first electrodes include a bus electrode extending in the first direction over the channels and include transparent electrodes traversing the bus electrode and extending over a pair of discharge cells neighboring each other in the second direction.

5. A plasma display panel comprising:
a front substrate;
a rear substrate facing the front substrate;
barrier ribs between the front substrate and the rear substrate to form discharge cells;
first electrodes and second electrodes on the front substrate extending in a first direction and facing each other in respective discharge cells with a discharge gap;
a dielectric layer covering the first electrodes and the second electrodes; and
a phosphor layer in each of the discharge cells,
wherein the barrier ribs have channels extending in the first direction, the channels being alternately disposed between a pair of discharge cells neighboring each other in a second direction crossing the first direction.

6. The plasmas display panel of claim 5, wherein
the discharge cells each have discharge cell width sides and discharge cell length sides longer than the discharge cell width sides, and
the discharge gap is biased towards the first electrodes such that the discharge gap is nearer to the discharge cell width sides nearest to the first electrodes than to the discharge cell width sides nearest to the second electrodes.

7. The plasma display panel of claim 5, wherein the second electrodes include a bus electrode extending in the first direction over the discharge cells and include transparent electrodes protruding from the bus electrode toward the first electrodes.

8. The plasma display panel of claim 5, wherein the first electrodes include a bus electrode extending in the first direction over the channels and include transparent electrodes traversing the bus electrode and extending over a pair of discharge cells adjacent to each other in the second direction.
